(19) United States
(12) Patent Application Publication
(10) Pub. No.: US 2004/0001953 A1
(43) Pub. Date: Jan. 1, 2004

(54) Method for manufacturing a transparent binderless storage phosphor screen

(76) Inventors: Luc Struye, Mortsel (BE); Paul Leblans, Kontich (BE)

Correspondence Address: Joseoh T. Guy Ph.D., Nexsen Pruet Jacobs & Pollard LLP, 201 W. McBee Avenue, Greenville, SC, 29603, US

(21) Appl. No.: 10/461,247

(22) Filed: Jun. 13, 2003

Related U.S. Application Data
(60) Provisional application No. 60/394,669, filed on Jul. 9, 2002.

(30) Foreign Application Priority Data
Jun. 28, 2002 (EP) 02100765.3

(51) Int. Cl. B32B 9/00

(52) U.S. Cl. 428/408; 428/704

(57) ABSTRACT

A method has been disclosed for manufacturing a binderless storage phosphor screen or panel comprising a support and a stimulable phosphor layer with a layer thickness in the range from 100 μm up to 1000 μm, said phosphor layer having a transparency of at least 50% for radiation in the wavelength range from 350 nm up to 750 nm, characterized in that said transparency has been provided by melting of a powdery phosphor or a phosphor present in structured form in a structured layer, at least in part, in order to get a liquid phosphor layer, followed by solidifying said liquid phosphor layer.

The application claims the benefit of U.S. provisional application No. 60/394,669 filed Jul. 09, 2002

### FIELD OF THE INVENTION

The present invention relates to a binderless storage phosphor screen having a stimulable phosphor for the latent storage of X-ray images and a method to manufacture it.

### BACKGROUND OF THE INVENTION

Storage phosphor screens are known in the art as screens wherein a latent X-ray image is stored when making use of a stimulable phosphor as a medium absorbing and storing radiation energy emitted by an X-ray source. Such X-rays, when having passed through an object (as e.g. a human body) provide the phosphor grains in the screen with a “latent image” which should be read out in order to make that “latent image” visible and ready for inspection by a medicine. Read-out of the X-ray image is achieved by exciting the phosphor with stimulating radiation (of longer wavelengths), thereby stimulating the phosphor to emit radiation of a shorter wavelength, which should be captured by a detector. Such a luminescent storage screen is disclosed, for example, in EP-A 0 174 875.

Holes become generated in the stimulable phosphor by incident radiant intensity, wherein these holes are stored in traps having a higher energy level, so that the latent X-ray image becomes stored in the screen, a process that seems to be very comparable with latent image formation in silver halide crystals in classical photography. Processing however proceeds in a quite differing way: whereas in classical silver halide photography wet processing of a silver halide film material proceeds in a processing cycle throughout the steps of developing, fixing, rinsing and drying, processing of digital images requires read-out of the entire area or surface of a storage screen or panel: stimulation, pixel-by-pixel, by another radiation source, e.g. a laser, causes stimulated radiation to leave the storage panel and to be detected by a detector. Due to the stimulation radiation, the energy of the holes stored in the traps is boosted and they can fall back into lower energy levels, whereby the energy difference is radiated in the form of light quanta. The stimulable phosphor thereby emits light dependent on the energy stored in the phosphor. The light emitted as a result of this stimulation is detected and rendered visible, so that the x-ray image which was latently stored in the screen can be read out. A problem in the read-out of such screens is that the stimulable phosphor is not sufficiently transparent for the stimulable laser light. A minimum thickness of the stimulable phosphor is required to be able to achieve adequate X-ray quantum absorptions. In case however of a non-transparent, tightly compressed or sintered phosphor, the laser beam is so greatly attenuated by the phosphor that the penetration depth of the laser beam is too small. Because the energy is no longer adequate for boosting the holes to the energy level required for quantum emission, the information stored in the deeper levels cannot be read out and speed of the storage phosphor screen is reduced. Moreover as the storage phosphor particles are embedded in a binder, it is important that the said binder is made of a light-transmissive carrier material, fixing the phosphor grains. Transparency for both stimulation and stimulated radiation is thus required, in favour of speed. Besides its influence on speed, influence on sharpness of the captured image is another weakness: incident radiation indeed spreads increasingly with increasing penetration depth, due to scattering of the radiation beam at the phosphor grains, so that the modulation transfer function of the overall system is degraded. Providing a binderless stimulable CsBr:Eu phosphor, prepared as described in EP-A 1 203 394 and vapour-deposited in needle-shaped form as disclosed in EP-A 1 113 458 onto a carrier in a high vacuum, was forming a suitable solution for an excellent speed-to-sharpness balance. As it was inevitable to have voids between the needles, further attempts to fill the said voids have more recently been described in EP-Applications Nos. 01000695, filed Dec. 3, 2001; 02100235, filed Mar. 8, 2002, and 02100296, filed Mar. 26, 2002, wherein filling voids has been realized by measures related with application of a radiation-curable protection layer liquid, a polymeric compound and sublimated dyes respectively. Filling the voids should be considered as an alternative for needle-shaped phosphors in order to avoid destruction of the needles by compression, as well-known applied technique for powder phosphors, in order to enhance their package density in a screen. It is not excluded that powder phosphors taking advantage with respect to speed by such compression action degrade with respect to sharpness as particle boundaries between powder particles may act as scatter centers for read-out radiation.

Further measures related with support or subbing layers onto said support, taken in favour of speed and sharpness for panels with same phosphors, have been described in recent EP-Applications Nos. 01000696 and 01000697, filed both Dec. 3, 2001; and 02100195, filed Feb. 28, 2002.

From the considerations related with speed and sharpness of storage phosphor panels given hereinbefore, it is clear that there remains a stringent demand for measures in order to overcome all losses in speed and image definition.

### OBJECTS AND SUMMARY OF THE INVENTION

It is an object of the present invention to provide a method for manufacturing a binderless storage screen of the type described above which produces a storage screen having a high X-ray quantum absorption with high imaging sharpness, an excellent modulation transfer function, and which is easy to manufacture.

The above object has been achieved in accordance with the principles of the present invention in a method for manufacturing a transparent binderless storage phosphor screen wherein said transparency is realized by melting a CsBr:Eu phosphor, in order to provide a better image sharpness. The “single-crystal” layer thus formed, apart from absence of voids and centers which are normally giving rise to scattering phenomena, provides high image definition (sharpness).

The above-mentioned advantageous effects have thus been realized by providing a phosphor sheet or panel having the specific features set out in claim 1. Specific features for preferred embodiments of the invention are set out in the dependent claims.

Further advantages and embodiments of the present invention will become apparent from the following description.

### BRIEF DESCRIPTION OF THE FIGURE

FIG. 1 shows an X-ray image from a lead screen in form of a grill in order to illustrate the sharpness of the image obtained with a solidified single-crystal CsBr:Eu phosphor layer as an X-ray capturing and storing medium, after having read-out said phosphor layer.

### DETAILED DESCRIPTION OF THE INVENTION

A method for manufacturing a binderless storage phosphor screen comprising a support and a stimulable phosphor layer with a layer thickness in the range from 100 μm up to 1000 μm, said phosphor layer having a transparency of at least 50% for radiation in the wavelength range from 350 nm up to 750 nm has thus been provided, characterized in that said transparency has been realized by melting of a powdery phosphor or a phosphor present in structured form in a structured layer, at least in part, in order to get a liquid phosphor layer, followed by solidifying said liquid phosphor layer. In a more preferred embodiment the transparency of the layer is at least 70% and most preferably even at least 90%.

According to the method of the present invention, melting proceeds by heating said phosphor up to a temperature exceeding its melting temperature. Exceeding the temperature is limited to a difference of at most 40° C., more preferably, less than 20° C. and even most preferably up to at most 10° C. Heating may proceed in a controlled—not too fast—way, by means of heating sources as electrically heating, by induction, by an infra-red source and the like.

According to another method of the present invention, melting of said powdery phosphor proceeds on a heat-resistant support or in a crucible, followed by coating (pouring) onto said heat-resistant support and cooling (in order to solidify the coating).

The melting process according to the method of the present invention, in a first embodiment, starts from the phosphor particles in powdery form or from phosphor particles after having been coated on a screen or panel support.

So in the said first embodiment phosphors in powdery form are brought onto a panel or screen support or substrate, without a binder, and are heated up to the melting point. Heating may proceed in an oven, wherein it is required to exceed the melting temperature of the phosphor powder. The way in which this energy will be added to the phosphor powder is decisive for the choice of the support medium: metallic, heat-conducting supports will be very suitable as heating can proceed without unevenness, over the whole surface of the support, as well as over the depth of the phosphor layer. Such a metallic heat-conducting support may e.g. be an aluminum layer having a thickness from 100 μm up to 5000 μm. When a heat-conducting, heat-resistant support is present, heating of the support as such is recommended. Heating may further proceed, under well-controlled conditions, e.g. by induction. Common applied temperatures for phosphors in order to bring them in the desired molten aggregation state are in the range of about 700-800° C. In an oven heating may moreover be performed under changing conditions of gaseous compositions and/or of pressure of the said gaseous compositions.

In another embodiment the powdery phosphors are molten in a crucible, again up to temperatures in the range as set forth, before being coated onto a suitable support, which again may be a metallic support or another heat-resistant support as e.g. a ceramic support, glassy carbon and carbon-carbon composites in general, Pertinax®, Kevlar®, quartz, molybdenum, tungsten, Iconel® Stellite-6®, stainless steel, titanium, titanium alloys, nickel-chromium and nickel-thoria alloys, structural intermetallics, structural ceramics, cermets and cemented carbides, stones as more particularly slate, marble-like and glazed stones, without however being limited thereto.

A coating step of the molten phosphor will thus be performed in that method and the surface tension of the molten phosphor and the viscosity, as well as changes (abrupt or in controlled conditions) will be decisive for the homogeneity and transparency of the thus obtained layers. Deviations from the average transparency over the layer should be less than 20%, more preferably less than 10% and most preferably even not more than 5%. As a consequence it has further been established that when applying the method described above, differences in speed and sharpness over the solidified phosphor foil are lower than 10% and in some cases even lower than 5%.

According to another method of the present invention, said method proceeds by melting of a phosphor present in structured form in a structured layer, and more particularly, by heating said layer on one or both sides of said phosphor layer.

A quite differing method starts from phosphors having been prepared by chemical vapour deposition under vacuum, as the phosphors described in WO 01/03156 and the corresponding EP-A 1 203 394 and, more particularly from the needle-shaped Eu-activated alkali metal halide phosphors described in EP-A 1 113 458, providing structured phosphor layers.

The storage phosphor used in a panel or screen of the present invention is preferably an alkali metal storage phosphor. Such a phosphor is disclosed in U.S. Pat. No. 5,736,069 and corresponds to the formula: M¹⁺X.aM²⁺X′₂bM³⁺X″₃:cZ

wherein: M¹⁺ is at least one member selected from the group consisting of Li, Na, K, Cs and Rb,

M²⁺ is at least one member selected from the group consisting of Be, Mg, Ca, Sr, Ba, Zn, Cd, Cu, Pb and Ni,

M³⁺ is at least one member selected from the group consisting of Sc, Y, La, Ce, Pr, Nd, Pm, Sm, Eu, Gd, Tb, Dy, Ho, Er, Tm, Yb, Lu, Al, Bi, In and Ga,

Z is at least one member selected from the group Ga¹⁺, Ge²⁺, Sn²⁺, Sb³⁺ and As³⁺,

X, X′ and X″ can be the same or different and each represents a halogen atom selected from the group consisting of F, Br, Cl, I and 0≦a≦1, 0≦b≦1 and 0<c≦0.2.

An especially preferred phosphor for use in a panel or screen of this invention is a CsX:Eu stimulable phosphor, wherein X represents a halide selected from the group consisting of Br and Cl, produced by a method comprising the steps of:

mixing said CsX with between 10⁻³ and 5 mol % of an Europium compound selected from the group consisting of EuOX′, EuX′₂ and EuX′₃, X′ being a member selected from the group consisting of F, Cl, Br and I;

firing said mixture at a temperature above 450° C.;

cooling said mixture and

recovering the CsX:Eu phosphor.

The most preferred CsBr:Eu phosphor, preferably being chemical vapour deposited in needle-shaped form onto a screen, sheet or panel is known to have voids inbetween the needles that have been deposited by chemical vapour deposition under vacuum. Melting such phosphor layers consisting of pillar-shaped blocks, in order to form one homogeneous and transparent layer provides a phosphor screen with an excellent image definition. An advantageous effect of needle-shaped and parallel oriented doped alkali halide phosphors as “light-piping” will however be lost up to a certain extent. Loss of “light-piping effect” as is the case with molten needle-shaped phosphors, originally oriented as described in EP-A 1 113 458, as a highly desirable orientation in view of absence of “lateral light-guidance”, which leads to propagation of emitted stimulated light, parallel to the support or which leads to total reflection thereof and loss in speed as being unable to escape from the phosphor layer, can be avoided by making use of an anti-reflecting layer. A subbing layer, not only present in favour of adhesion of the layers, may therefor be present between support and phosphor layer. Such a subbing layer is coated to the said substrate by coating an aqueous dispersion comprising a silicate and at least one pigment or dye, but in favour of antireflective properties and sharpness it is recommended to build-up such a subbing layer with at least one of MgF₂, silica (SiO₂) and at least one nanocrystalline dye compound(s), wherein dye compounds are preferred as described in EP-Application No. 02100296, filed Mar. 26, 2002, which moreover provide ability to become vapour deposited. Such a subbing layer has, in a preferred embodiment, a thickness in the range from 100 nm up to 50 μm, without however being restricted thereto.

Application of the “melting method” in structured phosphor layers, and more preferably in needle-shaped phosphor layers, should, according to the present invention, only proceed up to a certain depth in order to get the most favourable compromise. Needle-shaped CsBr:Eu²⁺ storage phosphor crystal particles in form of a cylinder suitable for use in flat storage phosphor panels provided as described in EP-Application No. 02100295, filed Mar. 26, 2002, e.g. have an average cross-section in the range from 1 μm up to 30 μm and an average length, measured along the casing of said cylinder, in the range from 100 μm up to 1000 μm.

An europium activated cesium bromide phosphor giving an increased stimulated emission amount, and which is also suitable for use in the screen or panel according to the present invention, is represented by the formula CsBr:xEu wherein 0<x≦0.2, in which a relationship between an emission intensity I_{E} of Eu²⁺ and a coloring intensity I_{F} at F (Br⁻) center satisfies the condition of 0.2≦I_{E}xI_{F}, and/or in which a ratio of Eu²⁺ to Eu³⁺ contained in the phosphor in terms of emission intensity satisfies the condition of 5×10⁻⁵≦Eu³⁺/Eu²⁺≦0.1 as has been described in U.S. applicattion Ser. No. 2002/0041977.

Phosphors of the type as mentioned hereinbefore require melting temperatures exceeding 760° C., whereafter solidification proceeds in order to get a transparent layer. In order to stimulate re-ordening or re-orientation of the molecules in the solidifying layer and in order to avoid cracking, it is recommended to slow down the solidifying process (at a rate of about 2° C.). In order to make a single crystal having large dimensions it is indeed recommended to provide more time for this process. It is moreover advantageous to perform the whole process in an inert atmosphere, as e.g. in a nitrogen or argon atmosphere under controlled pressure: a lower pressure may be advantageous, although in a step wherein evaporation of the deposited material should be avoided, it is recommended to provide a higher pressure.

According to the method of the present invention melting proceeds under controlled conditions at one surface of the structured phosphor layer of the panel by heating the said surface up to a depth in the range from 10 to 90% of the layer thickness. In a more preferred embodiment heating of the surface or surface layer of the needle-shaped phosphor layer proceeds up to a depth in the range from 30 to 70%. In this way the “partially structured screen” (in that part of the layer wherein needle-shaped crystals are still present) will still act as a “light-piping” entity (which dis-appears when melting the whole structured layer up to a depth of 100%), whereas in the surface part, where most X-ray absorption occurs, transparency of that partial layer provides an increase of speed, together with an excellent sharpness due to the optical characteristics at the surface of the phosphor layer. In the molten part of the phosphor layer it is clear that no voids are present: the melting process thus offers an alternative for other measures taken before in order to fill those voids, as has already been discussed in the background of the present invention. Melting may be provoked e.g. by bringing the surface layer of the needle-shaped binderless phosphor layer in contact with a heated flat, polished metal plate: controlled and homogeneous heating over the whole panel surface, up to a well-defined depth is recommended. The flat metal plate can moreover easily be removed and the partially molten panel surface can be covered with a protective layer. In another embodiment, the surface layer of the needle-shaped binderless phosphor layer is brought in contact with a heated “rough” metal plate, e.g. an aluminum plate with a well-defined “roughness” e.g. in the range from about 1 μm up to 2 μm, measured with a perth-o-meter. Instead of removing the metal plate after heating, the assembly can be cooled, so that adhesion of the, in part, molten phosphor layer is guaranteed. In this case it is recommended to provide the molten phase up to a depth in the range from about 5 up to about 20% and, more preferably, in the range from 5 up to 10%. As a further preferred action in that case, provided that the original needle-shaped binderless phosphor has originally been coated onto an easy peelable undercoat (providing low or moderate adhesion, being at least lower than the binding forces after melting between the molten part and the “rough” metal layer above) it is recommended to peel off the needle-shaped layer and to adhere the metal layer onto another substrate. Such a substrate or panel support may e.g. be same or another metal (adhesion by brazing) or another support (adhered by e.g. glueing by means of a suitable adhesive). A preferred support, without however being limited thereto, is e.g. amorphous carbon (having as characteristic advantage that X-rays will be absorbed to a much lesser extent than in the phosphor layer and in the metal layer inbetween). Once the panel provided on a suitable support is turned upside down, the melting process, making use of a flat, polished metal plate (or another heating source) may go on, just as described hereinbefore. Melting may thus be provided again up to a well-defined depth in order to get three phases in the phosphor layer, thus having a new design from the bottom (in contact with the support) up to the surface farther from the support: a molten phase, followed by a structured phase (containing needle-shaped crystals) and another molten phase up to the surface. According to the method of the present invention melting, in this case, melting proceeds under controlled conditions at both surfaces (of the originally structured phosphor layer) so that thickness ratios of three consecutive phase areas in the phosphor layer, being two outermost non-structured and an inner structured phase area, are in ranges from 0.1-1:3-9:7-1 from bottom to top said non-structured phase areas, and wherein both outermost areas are non-structured by melting, followed by solidifying.

In that way a compromise is found between losses, due to loss of “light-piping” (by lateral propagation of emitted light after stimulation) when melting needle-shaped phoshor crystals in a structured layer, and transparency, so that speed and sharpness are optimized. In this way 3 phases (2 non-structured, 1 needle-shape structured) have been realized in the originally completely structured phosphor layer.

In another embodiment only 2 phases (1 non-structured and 1 structured) are provided. Therefore in a most simple form, a needle-shaped structured phosphor layer becomes partially non-structured by only melting a surface part of it: this moreover lays less burden on the choice of a specific heat-resistant support layer.

As an energy source a lamp, a laser or a heated plate or layer emitting infra-red radiation may be sufficient to provoke melting of a thin surface layer. It is clear that it is preferred to have a shorter and more intense irradiation when melting up to a smaller depth is envisaged, as energy absorption is at its highest level at the topcoat surface and as that fraction of the surface is heated at the highest speed. Slow addition of energy (by providing infrared irradiation of lower intensity over a longer time period may be useful in order to get a higher fraction of the phosphor layer in a molten aggregation state. High energy addition over a longer time is not recommended as convection processes may occur in the molten layer up to an undefined irregular depth, and even up to the support, so that the degree of freedom, offered by choice of less heat-resistant supports (as polymeric supports like those known in the art as e.g. polyvinylchloride, polycarbonate, syntactic polystyrene, polyethyleneterephthalate films and polyethylenenaphthalate films, without however being limited thereto) disappears.

In all cases the flat surface with partially non-structured previously molten phosphor provides a flat base for depositing a protective layer, as e.g. the moisture-proof preferred parylene layer as described in EP-Application No. 02100298, filed Mar. 26, 2002. The method of forming a flat surface of a phosphor layer, and, more preferably a needle-shaped phosphor layer, is an alternative for polishing the surface of such a phosphor layer according to the method described in WO 02/20868.

The present invention thus provides a binderless storage phosphor screen or panel prepared according to the method described before, wherein the phosphor layer is composed of structured and non-structured areas in having same chemical composition. A method for manufacturing a transparent binderless storage phosphor screen providing excellent sharpness has thus been realized by increasing transparency of the binderless phosphor layer in the screen, for stimulating as well as for stimulated radiation, by bringing said phosphor particles, without a binder, on a support material in a molten aggregation state, followed by solidifying them.

A binderless storage phosphor panel or screen comprising a transparent phosphor layer thus becomes provided, wherein said screen or panel has been prepared according to the method described hereinbefore and wherein, in a preferred embodiment, the screen or panel is a binderless phosphor screen or panel, and wherein said phosphor layer comprises a CsX:Eu phosphor, X representing a halide selected from the group consisting of Br and Cl, and wherein the phosphor is present as one non-structured (soldified) transparent, preferably homogeneous layer (from the point of view of thickness as well as of chemical composition) or as a phosphor layer partially present in structured (needle-shaped) and in non-structured phases.

For a screen or panel according to the present invention a phosphor layer having a thickness in the range from 100 μm up to 1000 μm, one or more phases differing from the needle-shaped, structured phase are preferred. In one embodiment when only one phase is present, it is preferred to have one homogeneous phosphor layer, transparent for incident stimulating radiation and stimulated radiation leaving the phosphor layer. Speed increase can thus be expected in the first place because the light emitted by photostimulation escapes from the storage phosphor foil without being scattered in all directions, whereas the stimulation light from the laser source, which becomes scattered neither, mainly provokes excellent sharpness.

In a further more preferred embodiment according to the present invention the phosphor screen or panel still comprises a needle-shaped structured phase (of vacuum deposited, structured phosphor), present in the phosphor layer and even more preferred the needle-shaped phase has an adjacent transparent phosphor layer phase at both sides: one inbetween the substrate or support and the needle-shaped phase and one inbetween the needle-shaped phase and the outermost surface of the phosphor layer. It is further remarkable that, although having different phases in one and the same phosphor layer, the chemical composition of the phosphor layer is the same over the whole phosphor layer.

In the production of binderless phosphor screens by means of chemical vapour deposition in vacuum, the support on which the phosphor is deposited can be heated up to a temperature of about 400° C., so that use of a thermostable support is necessary. Therefore, though being a support containing only elements with low atomic number (Z), a polymeric support is not very suitable. An amorphous carbon film in the support opens perspectives in order to produce a binderless storage phosphor screen on a support with low X-ray absorption, even if the storage phosphor layer is applied by vacuum deposition at fairly high temperatures. Amorphous carbon films suitable for use in this invention are commercially available through, e.g., Tokay Carbon Co, LTD of Tokyo, Japan or Nisshinbo Industries, Inc of Tokyo, Japan, where they are termed “Glass-Like Carbon Film”, or “Glassy Carbon”. In a binderless phosphor panel or screen according to the present invention, the thickness of the amorphous carbon layer may range from 100 μm up to 3000 μm, a thickness between 500 μm and 2000 μm being preferred as a compromise between flexibility, strength and X-ray absorption. In another embodiment the support layer, which may be an amorphous carbon layer or another layer, is covered with a layer having a reflectivity of at least 80%. (which means that it preferably reflects at least 80% of the light impinging on it in a specular way). In that case it is recommended to have, besides a substrate with a surface roughness of less than 2 μm, being a metal (preferably aluminum) layer, the phase with the needle-shaped phosphor in contact with the substrate or separated from it by a thin transparent layer (as a result of partially melting the layer by the method as described before, followed by solidifying) in the range of up to at most about 20% of the total phosphor layer thickness, but more preferred less than 10% and even less, in favour of an extra increased sharpness through light-piping in the partially needle-shape structured phosphor layer. The thickness of the structured part of the phosphor layer then is in the range up to at least 20%, up to 90% and even more, if the structured part of the phosphor layer is extending up to the outermost surface, farther from the substrate support. In the alternative, the thickness of the structured part of the phosphor layer is in the range up to at most 70%, more preferably at most 50% and even more preferred at most 30%, if the structured part of the phosphor layer is not extending up to the outermost surface farther from the substrate support, but present as a solidified, previously molten part of the layer. More preferably said layer reflects 90% of the impinging light specularly. Such layers are preferably very thin metal layers having a thickness of less than 20 μm, preferably less than 10 μm. When in a screen or panel according to the present invention, a specularly reflecting layer is present, it is preferred that the layer be a thin aluminum layer (thickness preferably less than or equal to 10 μm, more preferably in the range from 0.2 μm up to 5 μm).

Since such a thin metal layer can be quite corrosion sensitive, it is preferred that, when a metal specularly reflecting layer is present in a panel or screen of this invention, that this layer be covered with a barrier layer (a further auxiliary layer) that impedes water and/or moisture of reaching the relecting auxiliary layer. Such a barrier layer may be any moisture barrier layer known in the art, but is preferably a layer of parylene. Most preferred polymers for use in the barrier layer of the present invention are vacuum deposited, preferably chemical vacuum deposited poly-p-xylylene film. A poly-p-xylylene has repeating units in the range from 10 to 10000, wherein each repeating unit has an aromatic nuclear group, whether or not substituted. As a basic agent the commercially available di-p-xylylene composition sold by the Union Carbide Co. under the trademark “PARYLENE” is thus preferred. The preferred compositions for the barrier layer are the unsubstituted “PARYLENE N”, the monochlorine substituted “PARYLENE C”, the dichlorine substituted “PARYLENE D” and the “PARYLENE HT” (a completely fluorine substituted version of PARYLENE N, opposite to the other “parylenes” resistant to heat up to a temperature of 400° C. and also resistant to ultra-violet radiation, moisture resistance being about the same as the moisture resistance of “PARYLENE C”). Most preferred polymers for use in the preparation of the barrier layer in a panel of this invention are poly(p-2-chloroxylylene), i.e. PARYLENE C film, poly(p-2,6-dichloroxylylene), i.e. PARYLENE D film and “PARYLENE HT” (a completely fluorine substituted version of PARYLENE N. The advantage of parylene layers as moisture barrier layers in a panel or screen of the present invention layer is the temperature resistance of the layers, the temperature resistance of the parylene layers is such that they can withstand the temperature need for vacuum depositing the storage phosphor. The use of parylene layers in storage phosphor screens has been disclosed in, e.g., EP-Applications, Nos. 02100297, 02100298 and 02100299, all of them being filed Mar. 26, 2002.

Thus a screen or a panel according to the embodiment of the present invention as set forth hereinbefore has a phosphor layer with stuctured and non-structured phases or parts as discussed hereinbefore, and a support, wherein the said support preferably includes an amorphous carbon layer, further with, between phosphor and amorphous carbon layer support, a specularly reflecting layer adjacent to the amorphous carbon layer and a parylene layer on top of the said reflecting layer.

A polymeric layer as an auxiliary layer discussed hereinafter is preferably laminated to the amorphous carbon layer.

Said auxiliary layer at the side opposite to the phosphor layer (“non-phosphor” side), preferably is a polymeric layer that is laminated to the amorphous carbon layer. By doing so the mechanical strength, especially with respect to brittleness and flexibility, of the panel or screen of the present invention is enhanced. The need for very high mechanical strength is especially present in the radiographic systems using a storage phosphor panel, wherein during reading of the energy stored in the panel, the panel is automatically removed from the cassette, moved through a reader, often via a sinuous path, and then put back in the cassette. In such a reader it is quite advantageous to use a screen or panel of the present invention with an auxiliary layer laminated on the amorphous carbon layer. This auxiliary layer can be any polymeric film known in the art, e.g. polyester film, polyvinylchloride, polycarbonate, syntactic polystyrene, etc.. Preferred polymeric films are polyester ester film, e.g., polyethyleneterephthalate films, polyethylenenaphthalate films, etc. The thickness of the auxiliary layer can range from 1 μm to 500 μm. It is possible to use a fairly thin amorphous carbon film, e.g., 400 μm and laminate a 500 μm thick auxiliary film to it as well as to use a thick amorphous carbon film, e.g., 2000 μm thick with a thin, e.g., 6 μm thick, polymeric film laminated to it. The relative thickness of the amorphous carbon and polymeric film can be varied widely and is only directed by the required physical strength of the amorphous carbon during deposition of the phosphor layer and the needed flexibility during use of the panel.

The screen or panel of the present invention moreover preferably includes, on top of the phosphor layer, any protective layer known in the art. Especially suitable for use are those protective layers disclosed in EP-Applications Nos. 02100297, filed Mar. 26, 2002; and 01000694 and 01000695, both filed Dec. 3, 2001 as well as glazed (stone) layers. Parylene, already discussed hereinbefore as a moisture-proof protective layer, is thus advangeously used again for that purpose.

As it is preferred that the phosphor layer in the panel according to the present invention is sandwiched between two moisture repellent layers, preferably both being composed of parylene as set forth hereinbefore, it is advantageous that the stimulable phosphor layer, comprised of non-structured as well as of structured phosphor phases is “surrounded” by a moisture-proof parylene “package” as in the vicinity of the edges, both parylene layers, contacting each other, indeed provide a moisture-proof construction. The screen or the panel of the present invention may further have reinforced edges as described in, e.g., U.S. Pat. No. 5,334,842 and U.S. Pat. No. 5,340,661.

The surface of the phosphor layer in a panel or screen of the present invention can be made smaller than the surface of the support so that the phosphor layer does not reach the edges of the support. Such a screen has been disclosed e.g. in EP-Application No. 02100297, filed Mar. 26, 2002.

The present invention further includes a method for producing a storage phosphor panel comprising the steps of:

providing a support (preferably an amorphous carbon film),

vacuum depositing a storage phosphor layer (of the preferred CsBr:Eu) composed of adjacent structured and non-structured phosphor layers having the same chemical composition on said (preferred amorphous carbon film) support and

optionally laminating a polymeric film on the side of (preferred amorphous carbon film) support not covered by said phosphor.

The present invention further includes a method for producing a storage phosphor panel comprising the steps of:

providing a support (preferably an amorphous carbon film),

applying a specularly reflecting layer on said (preferred amorphous carbon film) support,

vacuum depositing a storage phosphor layer composed of adjacent structured and non-structured phosphor layers having the same chemical composition (preferably CsBr:Eu) on said (preferred amorphous carbon film) support and

optionally laminating a polymeric film on the side of the (preferred amorphous carbon film)support not covered by said phosphor.

The invention moreover includes a method for producing a storage phosphor panel comprising the steps of:

providing a (preferred amorphous carbon film)support;

applying a specularly reflecting layer (preferably an aluminum layer) on said (preferred amorphous carbon film) support;

chemical vacuum depositing a parylene layer on top of said specularly reflecting layer,

vacuum depositing a storage phosphor layer composed of adjacent structured and non-structured phosphor layers having the same chemical composition on said (preferred amorphous carbon film) support and

optionally laminating a polymeric film on the side of the (preferred amorphous carbon film) support not covered by said phosphor.

The present invention moreover includes a method for exposing an object to X-rays comprising the steps of:

providing an X-ray machine including an X-ray tube equipped for emitting X-rays with an energy lower than or equal to 70 keV and a phototimer coupled to said X-ray tube for switching said tube on and off in accordance with an X-ray dose reaching said phototimer,

placing an object between said X-ray tube and said phototimer

placing a binderless storage phosphor panel or screen according to the present invention between said object and said phototimer and

activating said X-ray tube for exposing said object, said cassette and said phototimer until said phototimer switches said X-ray tube off.

As it is desired that the phototimer would work accurately, it is recommended to have a screen or panel support that has a poor absorption ability for X-rays having an energy as set forth, reason why a support composed of a component with a low atomic number amorphous carbon, discussed hereinbefore, is desired.

While the present invention will hereinafter be described in connection with preferred embodiments thereof, it will be understood that it is not intended to limit the invention to those embodiments.

### EXAMPLES

In an aluminum oxide crucible, the depth of which was decreased in order to mount it in a scanning apparatus afterwards, 0.5 grams of CsBr:Eu phosphor were put in an oven. In order to avoid contamination nitrogen was flushed throughout the environment while heating the phosphor material in the crucible very slowly, up to a temperature exceeding the melting temperature of 760° C. with at most 10° C.

Once the phosphor was in a molten aggregation state, a thin liquid, perfectly spread layer was formed on the bottom of the crucible.

Then the solidifying process was started by cooling the crucible at a rate of 2° C. per minute.

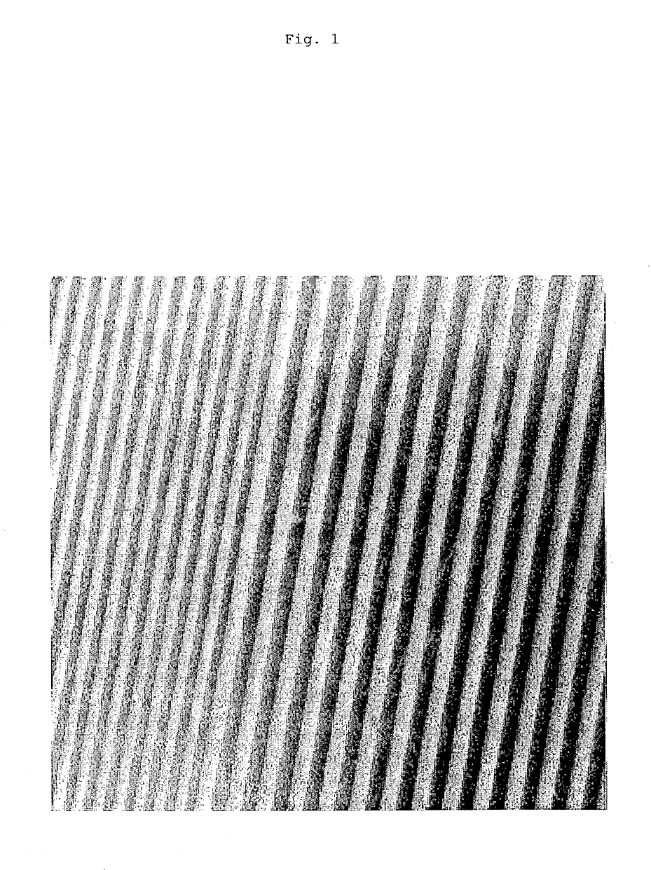

A relatively high speed was measured after having examined the solidified phosphor layer on the crucible support in the scanner, and it was even possible to get well-defined images from a lead screen in form of a grill in order to illustrate the sharpness of the image obtained with such a solidified single-crystal CsBr:Eu storage phosphor layer after having read out the said phosphor layer (see FIG. 1).

Electron-microscopic examination was further illustrative in order to show a very smooth surface of the previously molten, solidified phosphor layer.

Having described in detail preferred embodiments of the current invention, it will now be apparent to those skilled in the art that numerous modifications can be made therein without departing from the scope of the invention as defined in the appending claims.

1. Method for manufacturing a binderless storage phosphor screen or panel comprising a support and a stimulable phosphor layer with a layer thickness in the range from 100 μm up to 1000 μm, said phosphor layer having a transparency of at least 50% for radiation in the wavelength range from 350 nm up to 750 nm, characterized in that said transparency has been provided by melting of a powdery phosphor in order to get a liquid phosphor layer, followed by solidifying said liquid phosphor layer.

2. Method for manufacturing a binderless storage phosphor screen or panel comprising a support and a stimulable phosphor layer with a layer thickness in the range from 100 μm up to 1000 μm, said phosphor layer having a transparency of at least 50% for radiation in the wavelength range from 350 nm up to 750 nm, characterized in that said transparency has been provided by melting of a phosphor present in structured form in a structured layer, at least in part, in order to get a liquid phosphor layer, followed by solidifying said liquid phosphor layer.

3. Method according to claim 1, wherein melting proceeds by heating said phosphor up to a temperature exceeding its melting temperature on a heat-resistant support.

4. Method according to claim 1, wherein melting proceeds by heating said phosphor in a crucible up to a temperature exceeding its melting temperature, followed by coating onto a heat-resistant support.

5. Method according to claim 2, wherein melting of a phosphor present in a structured phosphor layer proceeds by heating said layer on one side of said phosphor layer.

6. Method according to claim 2, wherein melting of a phosphor present in a structured phosphor layer proceeds by heating said layer on both sides of said phosphor layer.

7. Method according to claim 5, wherein melting proceeds under controlled conditions at one surface of the structured phosphor layer by heating the said surface up to a depth in the range from 10 to 90% of the layer thickness.

8. Method according to claim 6, wherein melting proceeds under controlled conditions at both surfaces so that thickness ratios of three consecutive phase areas in the phosphor layer, being two outermost non-structured and an inner structured phase area, are in ranges from 0.1-1:3-9:7-1 from bottom to top, and wherein both outermost areas are non-structured by melting, followed by solidifying said non-structured phase areas.

9. Storage phosphor screen or panel prepared according to the method of claim 5, wherein the phosphor layer is composed of structured and non-structured areas have same chemical composition.

10. Storage phosphor screen or panel prepared according to the method of claim 6, wherein the phosphor layer is composed of structured and non-structured areas have same chemical composition.

11. Storage phosphor screen or panel prepared according to the method of claim 7, wherein the phosphor layer is composed of structured and non-structured areas have same chemical composition.

12. Storage phosphor screen or panel prepared according to the method of claim 8, wherein the phosphor layer is composed of structured and non-structured areas have same chemical composition.

13. Storage phosphor screen or panel prepared according to the method of claim 2, wherein said phosphor screen or panel comprises a needle-shaped structured phase in the phosphor layer.

14. Storage phosphor screen or panel prepared according to the method of claim 5, wherein said phosphor screen or panel comprises a needle-shaped structured phase in the phosphor layer.

15. Storage phosphor screen or panel prepared according to the method of claim 6, wherein said phosphor screen or panel comprises a needle-shaped structured phase in the phosphor layer.

16. Storage phosphor screen or panel prepared according to the method of claim 7, wherein said phosphor screen or panel comprises a needle-shaped structured phase in the phosphor layer.

17. Storage phosphor screen or panel prepared according to the method of claim 8, wherein said phosphor screen or panel comprises a needle-shaped structured phase in the phosphor layer.

18. Storage phosphor screen or panel prepared according to the method of claim 9, wherein said phosphor screen or panel comprises a needle-shaped structured phase in the phosphor layer.

19. Storage phosphor screen or panel prepared according to the method of claim 10, wherein said phosphor screen or panel comprises a needle-shaped structured phase in the phosphor layer.

20. Storage phosphor screen or panel prepared according to the method of claim 11, wherein said phosphor screen or panel comprises a needle-shaped structured phase in the phosphor layer.

21. Storage phosphor screen or panel prepared according to the method of claim 12, wherein said phosphor screen or panel comprises a needle-shaped structured phase in the phosphor layer.

22. Storage phosphor screen or panel prepared according to the method of claim 13, wherein said needle-shaped phase has an adjacent transparent phosphor layer phase at both sides.

23. Storage phosphor screen or panel prepared according to the method of claim 14, wherein said needle-shaped phase has an adjacent transparent phosphor layer phase at both sides.

24. Storage phosphor screen or panel prepared according to the method of claim 15, wherein said needle-shaped phase has an adjacent transparent phosphor layer phase at both sides.

25. Storage phosphor screen or panel prepared according to the method of claim 16, wherein said needle-shaped phase has an adjacent transparent phosphor layer phase at both sides.

26. Storage phosphor screen or panel prepared according to the method of claim 17, wherein said needle-shaped phase has an adjacent transparent phosphor layer phase at both sides.

27. Storage phosphor screen or panel prepared according to the method of claim 18, wherein said needle-shaped phase has an adjacent transparent phosphor layer phase at both sides.

28. Storage phosphor screen or panel prepared according to the method of claim 19, wherein said needle-shaped phase has an adjacent transparent phosphor layer phase at both sides.

29. Storage phosphor screen or panel prepared according to the method of claim 20, wherein said needle-shaped phase has an adjacent transparent phosphor layer phase at both sides.

30. Storage phosphor screen or panel prepared according to the method of claim 21, wherein said needle-shaped phase has an adjacent transparent phosphor layer phase at both sides.

31. Storage phosphor screen or panel according to claim 22, having as a support an amorphous carbon layer and, between phosphor layer and amorphous carbon layer, a specularly reflecting layer adjacent to the amorphous carbon layer, with a parylene layer on top of said reflecting layer.

32. Storage phosphor screen or panel according to claim 23, having as a support an amorphous carbon layer and, between phosphor layer and amorphous carbon layer, a specularly reflecting layer adjacent to the amorphous carbon layer, with a parylene layer on top of said reflecting layer.

33. Storage phosphor screen or panel according to claim 24, having as a support an amorphous carbon layer and, between phosphor layer and amorphous carbon layer, a specularly reflecting layer adjacent to the amorphous carbon layer, with a parylene layer on top of said reflecting layer.

34. Storage phosphor screen or panel according to claim 25, having as a support an amorphous carbon layer and, between phosphor layer and amorphous carbon layer, a specularly reflecting layer adjacent to the amorphous carbon layer, with a parylene layer on top of said reflecting layer.

35. Storage phosphor screen or panel according to claim 26, having as a support an amorphous carbon layer and, between phosphor layer and amorphous carbon layer, a specularly reflecting layer adjacent to the amorphous carbon layer, with a parylene layer on top of said reflecting layer.

36. Storage phosphor screen or panel according to claim 27, having as a support an amorphous carbon layer and, between phosphor layer and amorphous carbon layer, a specularly reflecting layer adjacent to the amorphous carbon layer, with a parylene layer on top of said reflecting layer.

37. Storage phosphor screen or panel according to claim 28, having as a support an amorphous carbon layer and, between phosphor layer and amorphous carbon layer, a specularly reflecting layer adjacent to the amorphous carbon layer, with a parylene layer on top of said reflecting layer.

38. Storage phosphor screen or panel according to claim 29, having as a support an amorphous carbon layer and, between phosphor layer and amorphous carbon layer, a specularly reflecting layer adjacent to the amorphous carbon layer, with a parylene layer on top of said reflecting layer.

39. Storage phosphor screen or panel according to claim 30, having as a support an amorphous carbon layer and, between phosphor layer and amorphous carbon layer, a specularly reflecting layer adjacent to the amorphous carbon layer, with a parylene layer on top of said reflecting layer.
